(19) United States
(12) Patent Application Publication
(10) Pub. No.: US 2015/0161742 A1
(43) Pub. Date: Jun. 11, 2015

(54) AUTOMATIC DETERMINATION OF VEHICLE INFORMATION BASED ON TRANSACTION INFORMATION

(71) Applicant: MasterCard International Incorporated, Purchase, NY (US)

(72) Inventors: Kenny Unser, Fairfield, CT (US); Nikhil Malgatti, Stamford, CT (US); Serge Bernard, Danbury, CT (US)

(73) Assignee: MasterCard International Incorporated, Purchase, NY (US)

(21) Appl. No.: 14/098,881

(22) Filed: Dec. 6, 2013

(51) Int. Cl. G06Q 40/00; G06Q 50/06

(52) U.S. Cl. CPC G06Q 40/12; G06Q 50/06

(57) ABSTRACT

According to some embodiments, transaction information associated with payments made via a payment account (e.g., a credit card account) associated with an account owner may be retrieved from a transaction database. The retrieved transaction information may then be analyzed to automatically determine vehicle information associated with the account owner. For example, estimated driving information or predicted vehicle ownership information might be automatically determined.

### BACKGROUND

Vehicle information associated with a person may be of interest to various entities. For example, an insurance or advertising company might want to know how many miles per week a person typically drives to determine products and/or services that might be of interest to that particular person. Similarly, the type of vehicle currently being operated by a person may be of interest. For example, an automobile manufacturer might want to know which residents in a particular city currently drive hybrid gasoline/electric vehicles. Attempting to manually determine vehicle information for a group of people, such as by conducting a telephone or online survey, can be an expensive, time-consuming, and error prone task, especially when a substantial number of people are involved. As a result, systems and methods to automatically determine vehicle information may be desired.

### BRIEF DESCRIPTION OF THE DRAWINGS

FIG. 1 is a block diagram overview of a system according to some embodiments of the present invention.

FIG. 2 illustrates a method that might be performed in accordance with some embodiments.

FIG. 3 is block diagram of an analyzer tool or platform according to some embodiments of the present invention.

FIG. 4 is a tabular portion of a transaction database according to some embodiments.

FIG. 5 is a tabular portion of a merchant database in accordance with some embodiments.

FIG. 6 is a tabular portion of an account database according to some embodiments.

FIG. 7 illustrates an estimated driving information method that might be performed in accordance with some embodiments.

FIG. 8 is an example of a display that might be provided in accordance with some embodiments.

FIG. 9 illustrates a predicted vehicle ownership information method that might be performed in accordance with some embodiments.

FIG. 10 is a block diagram of a system including a predictive model generator according to some embodiments.

FIG. 11 is a flow chart illustrating how a predictive model might be generated according to some embodiments.

### DETAILED DESCRIPTION

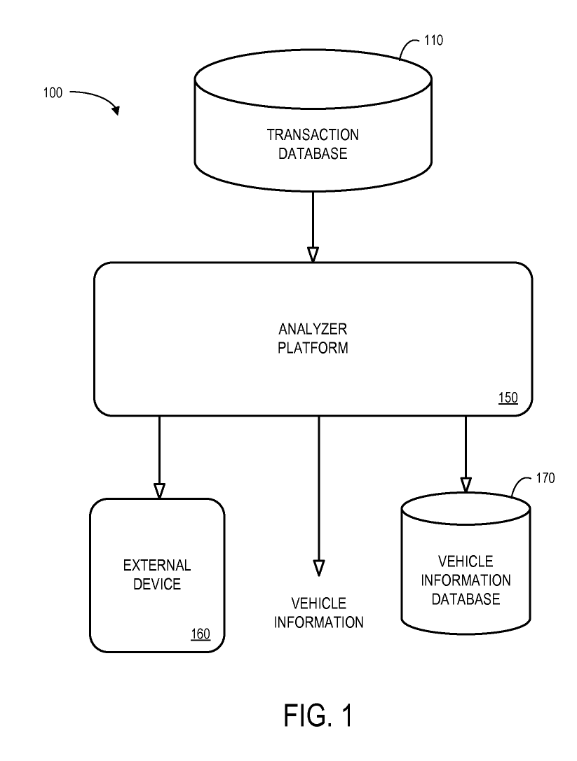

Vehicle information associated with a person may be of interest to various entities. For example, an insurance or advertising company might want to know how often a person drives a relatively long distance (e.g., over 200 miles in a single week). Similarly, the type of vehicle owned by a person may be of interest. For example, a marketing firm might be interested in finding out who owns European automobiles. Attempting to manually determine vehicle information for a group of people, such as by conducting a telephone or online survey, can be an expensive, time-consuming, and error prone task, especially when a substantial number of people are involved. It would therefore be desirable to provide accurate and efficient systems and methods to automatically determine vehicle information. FIG. 1 is block diagram of a system 100 according to some embodiments of the present invention. In particular, the system 100 includes an analyzer platform 150 that receives information from a transaction database 110 and outputs vehicle information, such as by outputting the vehicle information to an external device 160 and/or a vehicle information database 170.

The analyzer platform 150 might be, for example, associated with a Personal Computer (PC), laptop computer, an enterprise server, a server farm, and/or a database or similar storage devices. The analyzer platform 150 may, according to some embodiments, be associated with a credit card company.

According to some embodiments, an “automated” analyzer platform 150 may facilitate the determination of vehicle information. For example, the analyzer platform 150 may automatically output a list of people who drive relatively infrequently. As used herein, the term “automated” may refer to, for example, actions that can be performed with little (or no) intervention by a human.

As used herein, devices, including those associated with the analyzer platform 150 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The analyzer platform 150 may retrieve transaction information from the transaction database 110. The transaction database 110 might be associated with, for example, payment accounts, such as credit card or bank accounts. The transaction database 110 may be locally stored or reside remote from the analyzer platform 150. As will be described further below, the transaction database 110 may be used by the analyzer platform 150 to generate vehicle information. According to some embodiments, the analyzer platform 150 communicates vehicle information to an external device 160, such as by transmitting an electronic file to an email server, a workflow management system, etc. In other embodiments, the analyzer platform 150 might store vehicle information in a vehicle information database 170.

Although a single analyzer platform 150 is shown in FIG. 1, any number of such devices may be included. Moreover, various devices described herein might be combined according to embodiments of the present invention. For example, in some embodiments, the analyzer platform 150 and transaction database 110 might be co-located and/or may comprise a single apparatus.

In accordance with some embodiments, the systems and methods described herein provide a framework to determine vehicle information based on transaction information associated with payment accounts. For example, a payment card may presented by a cardholder (e.g., the account owner) to make a payment. By way of example, and without limiting the generality of the foregoing, a payment card can be a credit card, debit card, charge card, stored-value card, or prepaid card or nearly any other type of financial transaction card. Further, as used herein in, the term “issuer” or “attribute provider” can include, for example, a financial institution (i.e., bank) issuing a card, a merchant issuing a merchant specific card, a stand-in processor configured to act on-behalf of the card-issuer, or any other suitable institution configured to issue a payment card. As used herein, the term “transaction” can be associated with, for example, a merchant, a merchant terminal, an automated teller machine (ATM), or any other suitable institution or device configured to initiate a financial transaction per the request of the account owner.

The information in the transaction database 110 may be associated with, for example, a “payment card processing system” or “credit card processing networks”, such as the MasterCard® network that allows account owners to use payment cards issued by a variety of issuers to shop at a variety of merchants. With this type of payment card, a card issuer or attribute provider, such as a bank, extends credit to an account owner to purchase products or services. When an account owner makes a purchase from an approved merchant, the card number and amount of the purchase, along with other relevant information, are transmitted via the processing network to a processing center, which verifies that the card has not been reported lost or stolen and that the card's credit limit has not been exceeded. In some cases, the account owner's signature is also verified, a personal identification number is required or other user authentication mechanisms are imposed. The account owner is required to repay the bank for the purchases, generally on a monthly basis.

The transaction database 110 may further store a “business classification,” which is a group of merchants and/or businesses, by the type of goods and/or service the merchant and/or business provides. For example, the group of merchants and/or businesses can include merchants and/or business, which provide similar goods and/or services. In addition, the merchants and/or businesses can be classified based on geographical location, sales, and any other type of classification, which can be used to associate a merchant and/or business with similar goods, services, locations, economic and/or business sector, industry and/or industry group.

The transaction database 110 may also store a “merchant category code” or “MCC,” which is a four-digit number created by MasterCard® or VISA® and assigned to a business by the acquirer when the business first starts accepting one of these cards as a form of payment. The MCC is used to classify the business by the type of goods or services it provides. For example, in the United States, the merchant category code can be used to determine if a payment needs to be reported to the IRS for tax purposes. In addition, Merchant Category Codes (or “MCCs”) are used by card issuers to categorize, track or restrict certain types of purchases.

In accordance with some embodiments, data associated with payment card transactions is stored within the transaction database 110. The data may include, for example, a listing of sales amount for each payment card transaction including the type of goods and/or services sold, a total number of goods and/or services sold in each transaction, a total sales amount for each transaction (e.g., gross dollar amount). In addition, for each merchant and/or business, the data associated with each transaction may include a point-of-sale or point-of-purchase (e.g., location of each payment card transaction). The point-of-sale or point-of-purchase provides that for merchants and/or businesses having one or more locations, the location of the merchant and/or business, which generated the sale can be identified.

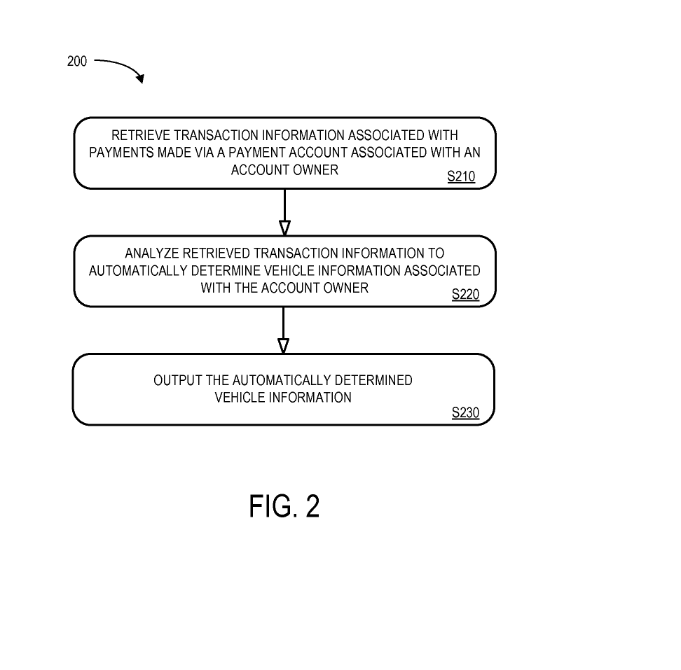

FIG. 2 illustrates a method that might be performed by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, transaction information associated with payments made via a payment account, associated with an account owner, may be retrieved from a transaction database. The payment account may be associated, for example, a credit card account, a debit card account, a bank account, a pre-paid card account, or any other type of payment account. The transaction information may include, for example, an account identifier, a merchant identifier, a date, a time of day, a payment amount, a payment description, or any other type of transaction information.

At S220, the retrieved transaction information may be analyzed to automatically determine “vehicle” information associated with the account owner. As used herein, the term “vehicle” might refer to, for example, an automobile, a truck, a construction vehicle, a motorcycle, a boat, a snowmobile, and/or an airplane. Moreover, the phrase “vehicle information” may refer to estimated driving information, predicted vehicle ownership information, or any other type of vehicle information. At S230, the automatically determined vehicle information may be output. For example, the vehicle information might be displayed on a computer monitor, transmitted in a computer file, and/or stored in a database.

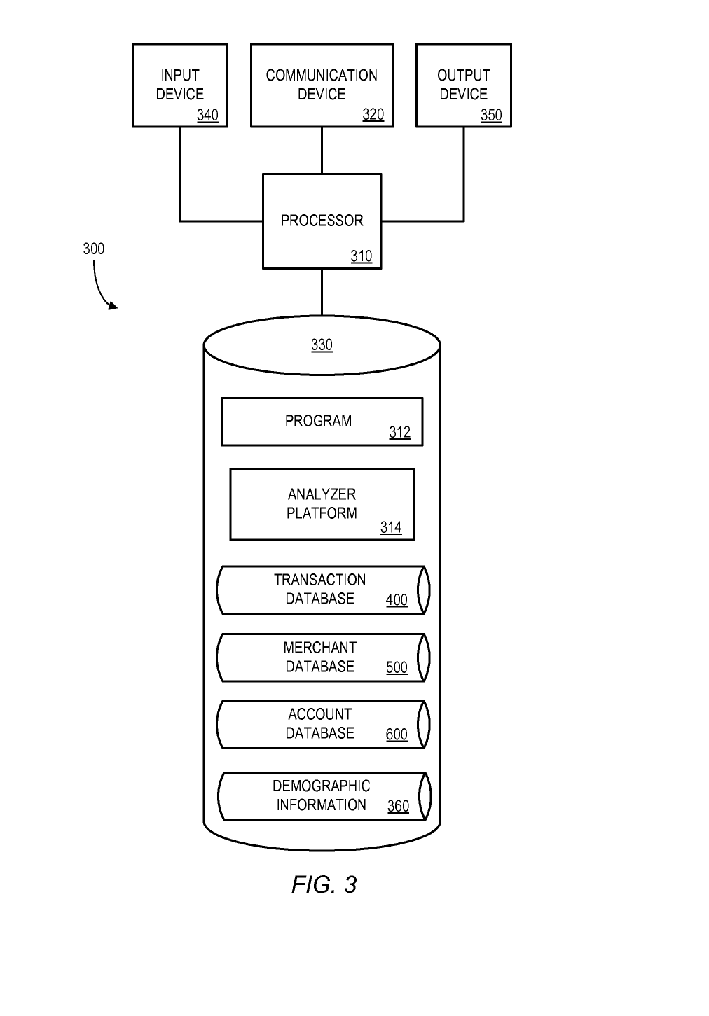

In this way, transaction information may be analyzed to automatically determine vehicle information. Note that the embodiments described herein may be implemented using any number of different hardware configurations. For example, FIG. 3 illustrates an analyzer platform 300 that may be, for example, associated with the system 100 of FIG. 1. The analyzer platform 300 comprises a processor 310, such as one or more commercially available Central Processing Units (CPUs) in the form of one-chip microprocessors, coupled to a communication device 320 configured to communicate via a communication network (not shown in FIG. 3). The communication device 320 may be used to communicate, for example, with one or more transaction databases. The analyzer platform 300 further includes an input device 340 (e.g., a computer mouse and/or keyboard to enter information about vehicle rules or models) and an output device 350 (e.g., a computer monitor or printer to output a vehicle information report).

The processor 310 also communicates with a storage device 330. The storage device 330 may comprise any appropriate information storage device, including combinations of magnetic storage devices (e.g., a hard disk drive), optical storage devices, mobile telephones, and/or semiconductor memory devices. The storage device 330 stores a program 312 and/or analyzer platform logic 314 for controlling the processor 310. The processor 310 performs instructions of the programs 312, 314, and thereby operates in accordance with any of the embodiments described herein. For example, the processor 310 may retrieve transaction information associated with payments made via a payment account (e.g., a credit card account), associated with an account owner, from a transaction database. The retrieved transaction information may then be analyzed by the processor 310 to automatically determine vehicle information associated with the account owner. For example, estimated driving information or predicted vehicle ownership information might be automatically determined by the processor 310.

The programs 312, 314 may be stored in a compressed, uncompiled and/or encrypted format. The programs 312, 314 may furthermore include other program elements, such as an operating system, a database management system, and/or device drivers used by the processor 310 to interface with peripheral devices.

As used herein, information may be “received” by or “transmitted” to, for example: (i) the analyzer platform 300 from another device; or (ii) a software application or module within the analyzer platform 300 from another software application, module, or any other source.

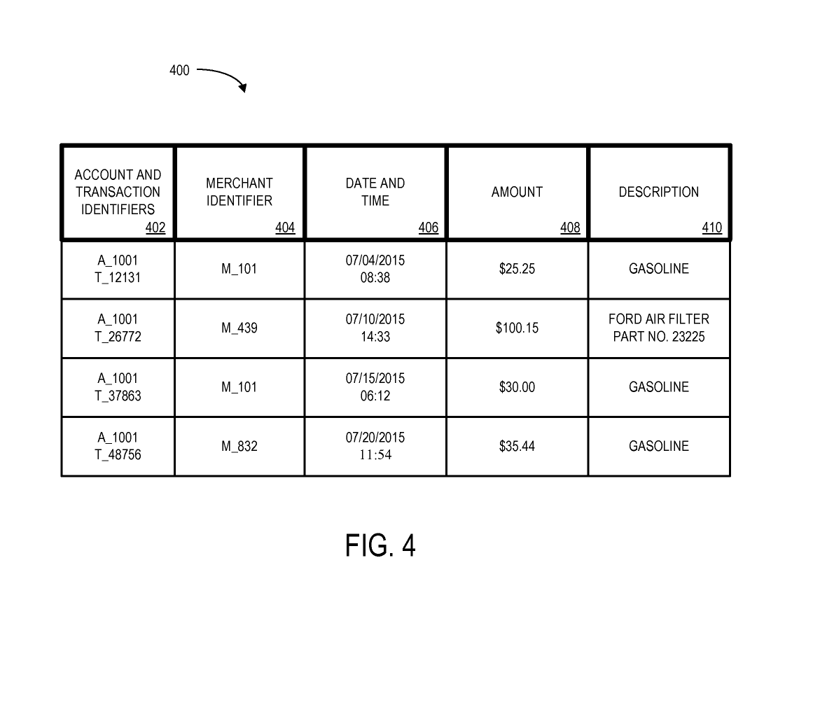

In some embodiments (such as shown in FIG. 3), the storage device 330 further stores a transaction database 400, a merchant database 500, an account database 600, and demographic information 360. Some examples of databases that may be used in connection with the analyzer platform 300 will now be described in detail with respect to FIGS. 4 through 6. Note that the databases described herein are only examples, and additional and/or different information may actually be stored therein. Moreover, various databases might be split or combined in accordance with any of the embodiments described herein. For example, the account database 600 and demographic database 360 might be combined and/or linked to each other within the analyzer platform 300.

Referring to FIG. 4, a table is shown that represents the transaction database 400 that may be stored at the analyzer platform 300 according to some embodiments. The table may include, for example, entries identifying transactions that have been processed via a payment account (e.g., credit card transactions). The table may also define fields 402, 404, 406, 408, 410 for each of the entries. The fields 402, 404, 406, 408, 410 may, according to some embodiments, specify: account and transaction identifiers 402, a merchant identifier 404, a date and time 406, an amount 408, and a description 410. The transaction database 400 may be created and updated, for example, based on information electrically received on a periodic basis.

The account identifier 402 may be, for example, a unique alphanumeric code identifying a payment account, such as a Primary Account Number (“PAN”). The transaction identifier 402 may be associated with a particular transaction (e.g., a purchase at a gas station). The date and time 406 may indicate when the transaction occurred, and the amount 408 may indicate the monetary amount of the transaction. The description may indicate what was purchased in the transaction (e.g., a general indication that a credit card was used at a gasoline pump, a type of goods or services typically offered by the merchant, etc.).

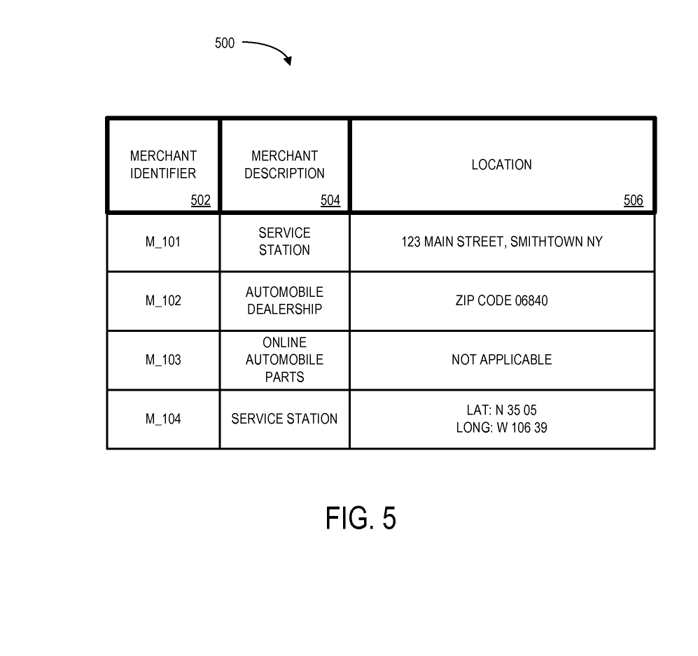

Referring to FIG. 5, a table is shown that represents the merchant database 500 that may be stored at the analyzer platform 300 according to some embodiments. The table may include, for example, entries identifying merchants involved in the transactions. The table may also define fields 502, 504, 506 for each of the entries. The fields 502, 504, 506 may, according to some embodiments, specify: a merchant identifier 502, a merchant description 504, and a location 506. The merchant database 500 may be created and updated, for example, based on information electrically received on a periodic basis.

The merchant identifier 502 may be, for example, a unique alphanumeric code identifying a merchant and may, or may not, be associated with the merchant identifier 404 in the transaction database 400. The merchant description 504 may be associated with, for example, an MCC or other data indicating the type of goods and/or services offered by the merchant. The location 506 may, for example, comprise an address, a ZIP code, a latitude and longitude, or any other information associated with the merchant's geographic location.

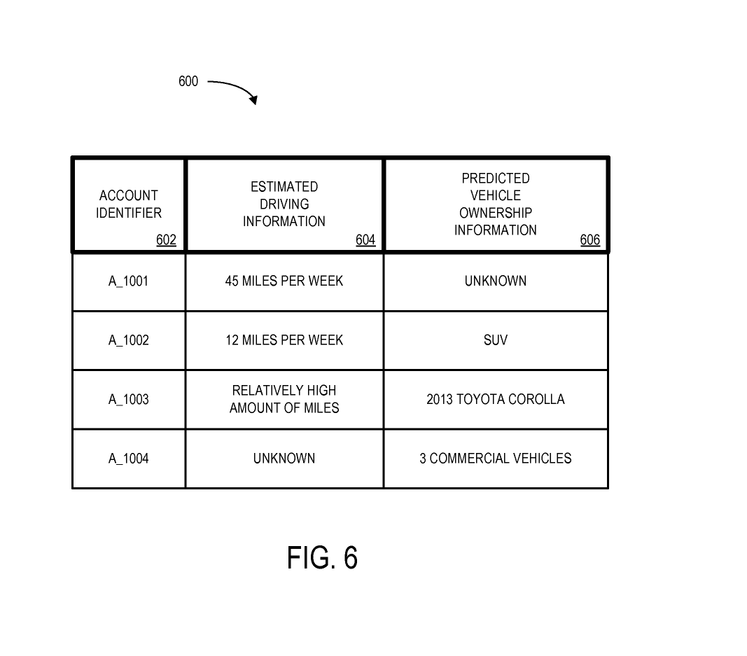

Referring to FIG. 6, a table is shown that represents the account database 600 that may be stored at the analyzer platform 300 according to some embodiments. The table may include, for example, entries identifying payment accounts associated with the transactions. The table may also define fields 602, 604, 606 for each of the entries. The fields 602, 604, 606 may, according to some embodiments, specify: an account identifier 602, estimated driving information 604, and predicted vehicle ownership information 606. The account database 600 may be created and updated, for example, automatically by an analyzer platform based on transaction data.

The account identifier 602 may be, for example, a unique alphanumeric code identifying a payment account and may, or may not, be associated with the account identifier 402 in the transaction database 400. The estimated driving information 604 may, for example, indicate how far the account owner typically drives over a given period of time (e.g., miles-per-week or miles-per-year). The predicted vehicle ownership information 606 may, for example, indicate a type or model of vehicle that may be owned (including, for example, via a rental lease) by the payment account owner.

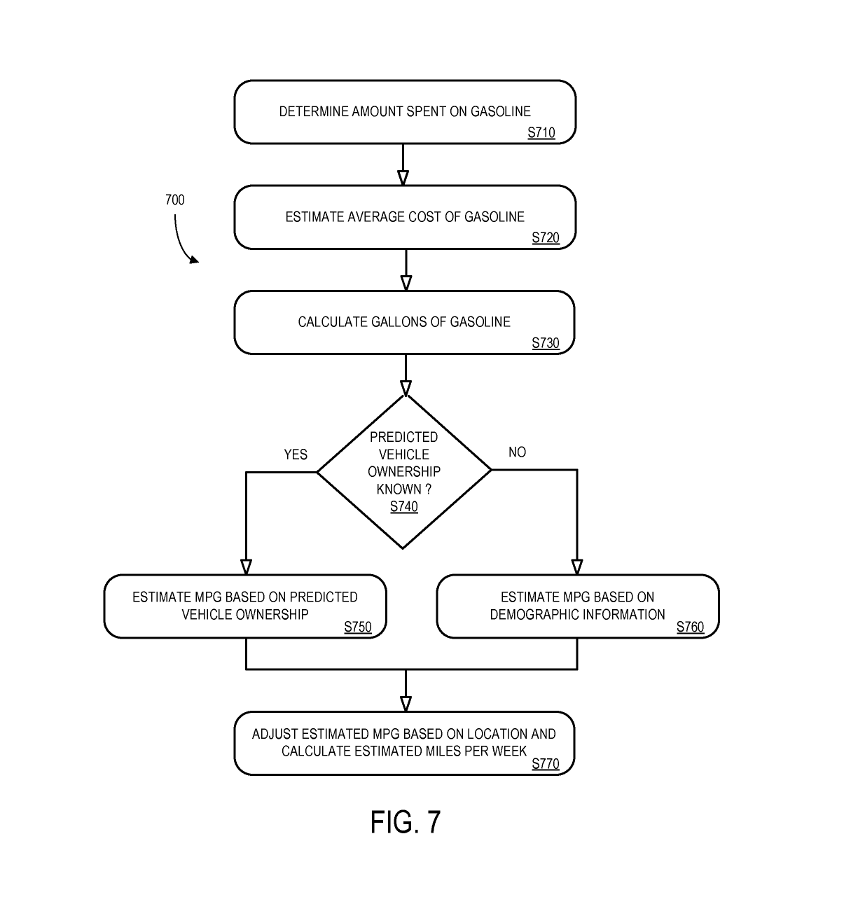

FIG. 7 illustrates an estimated driving information method that might be performed in accordance with some embodiments. At S710, an overall amount spent on gasoline via the payment account over a given period of time may be determined. For example, all transaction during a month might be reviewed to determine that an account owner has spent a total of $50.00 on gasoline during that month. At S720, an average cost of gasoline over the given period of time may be estimated. This might be based on, for example, a merchant's location, an account owner's home address, etc. This information may then be used at S730 to calculate a number of gallons of gasoline that were likely purchased by the account owner during that period of time (by dividing the overall amount spent by the price-per-gallon).

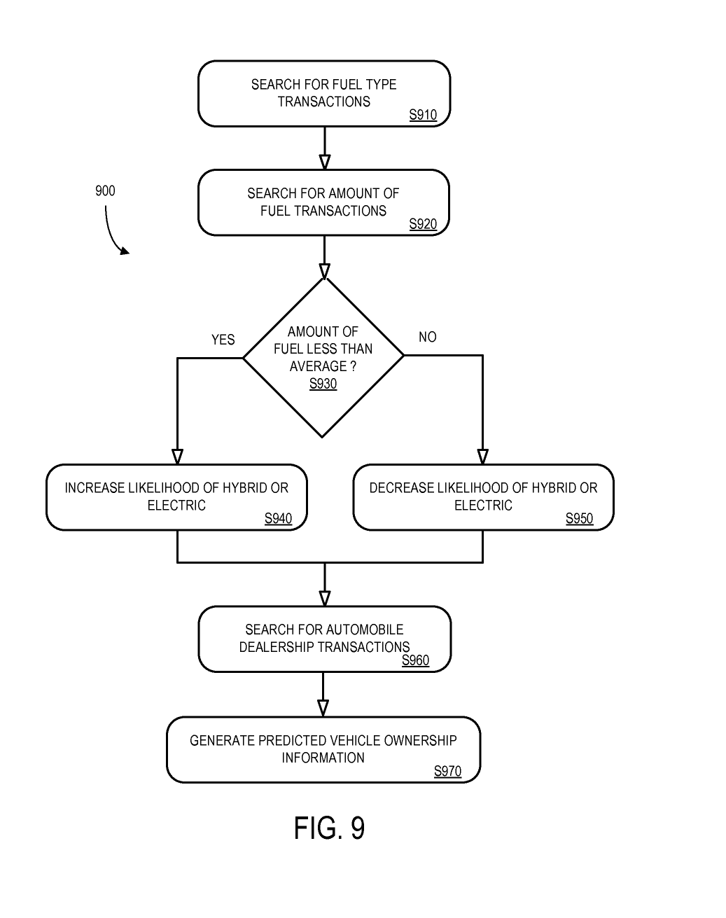

At S740, it is determined whether predicted vehicle ownership information is known for the account owner (e.g., as described with respect to FIG. 9). If predicted vehicle ownership information is known, a Miles-Per-Gallon (“MPG”) value for that make or model of vehicle is estimated at S750. If predicted vehicle ownership information is not known, a MPG value is estimated based on the account owner's demographic information at S760. In either case, the estimated MPG may be adjusted based on location information (e.g., if the account owner has purchased gasoline in a rural area the estimated MPG may be increased to reflect a “highway” MPG value).

Note that a single payment account may be used by more than one person. For example, multiple member of a family or business may use a payment account. Note that embodiments described herein may generate an estimated amount of miles driven by an account owner, an account owner's household, and/or an account owner's business. Moreover, the specific rules and logic of FIG. 7 are provided only as one example, and embodiments might estimate driving information based on, including any combination of: a type of fuel purchased, a fuel purchase frequency, merchant information, location information, and/or service station purchases.

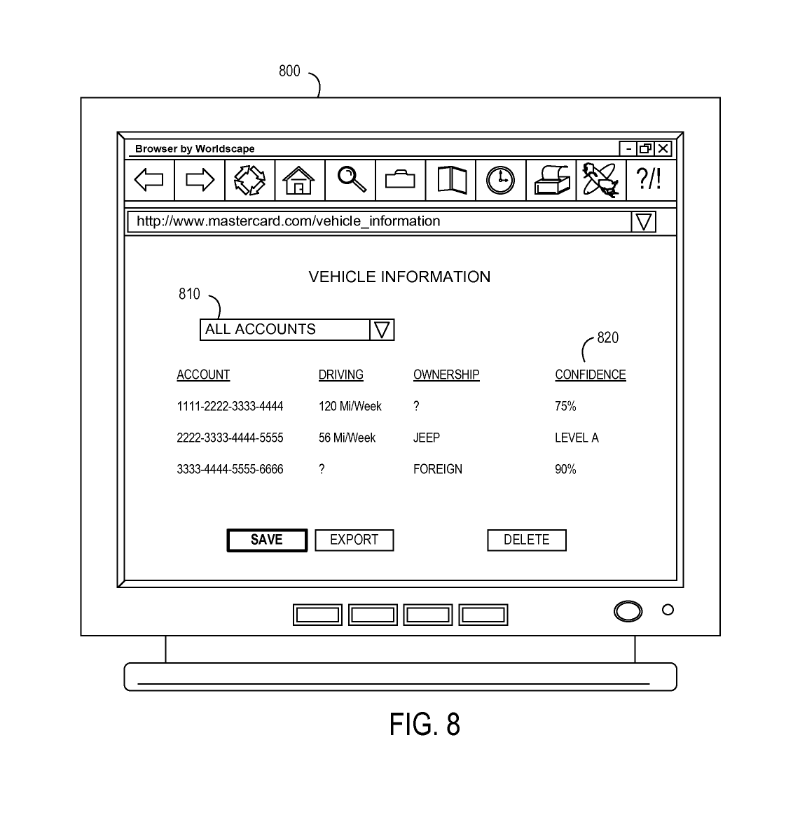

FIG. 8 is an example of a display 800 that might be provided in accordance with some embodiments. In particular, a user might select 810 which type of vehicle information should be included on the display (e.g., all payment account owners who are residents of California, all account owners who are under 35 years old, etc.). Moreover, as illustrated in FIG. 8, an analyzer platform may generate and display a “confidence level” associated with the vehicle information. The confidence level might indicate, for example, how likely it is that estimated or predicted vehicle information is actually correct (e.g., by a percentage likelihood or a confidence category).

FIG. 9 illustrates a predicted vehicle ownership information method 900 that might be performed in accordance with some embodiments. At S910, all transactions may be searched to determine if a particular type of fuel can be determined. For example, it may be determined if diesel or high-octane fuel has been purchased (and this, in turn, may influence the type of car that likely driven by the account owner). At S920, all transactions may be searched to determine if a particular amount of fuel can be determined (e.g., that the account owner purchased 5 gallons of gasoline during the month). If the amount of fuel is less than average (e.g., falls below a pre-determined threshold value or percentage) at S930, there may be an increased likelihood that the account owner drives a hybrid or electric vehicle at S940. If the amount of fuel is not less than average at S930, there may be a decreased likelihood that the account owner drives a hybrid or electric vehicle at S950. At S960, all transactions may be searched to determine if any transaction was made at an automobile dealership. For example, if an account owner spent $500 at a NISSAN automobile dealership, it may be more likely that he or she drives a NISSAN automobile. The predicted vehicle ownership information may then be generated at S970. As used herein, the phrase “predicted vehicle ownership information” might refer to, for example, a predicted vehicle type (e.g., SUV or sports car), a predicted vehicle manufacturer, a predicted vehicle model, and/or a plurality of vehicles.

Note that a single payment account may be used by more than one person. For example, multiple member of a family or business may use a payment account. Note that embodiments described herein may generate predicted vehicle ownership information for an account owner, an account owner's household, and/or an account owner's business. 10. Moreover, the specific rules and logic of FIG. 9 are provided only as one example, and embodiments might estimate driving information based on, including any combination of: a type of fuel purchased, an amount of fuel purchased, a fuel purchase frequency, an average price of fuel, an average miles-per-gallon vehicle rating, a city or highway average miles-per-gallon vehicle rating, merchant information, location information, service station purchases, demographic information, a vehicle replacement part purchase, and/or estimated driving information (e.g., as described with respect to FIG. 7).

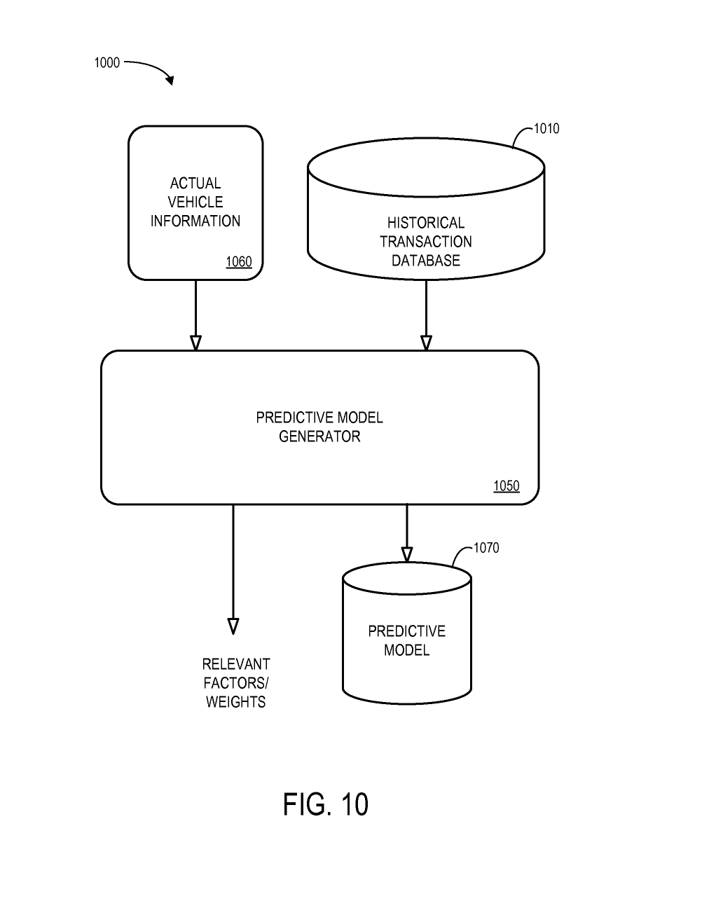

Note that rules and logic described with respect to FIGS. 7 and 9 might be manually designed and constructed by a human operator. In some cases, however, relevant factors in a transaction database may be automatically identified and/or used to create a predictive model. For example, FIG. 10 is a block diagram of a system 1000 including a predictive model generator 1050 according to some embodiments. The predictive model generator 1050 may receive actual vehicle information 1060 along with historical transaction database 1010 information. For example, historical credit card purchases may be received along with indications of the actual types of cars driven by those account owners (e.g., from a survey or Department of Motor Vehicle database).

The predictive model generator 1050 may look for patterns in the historical transaction information to identify relevant factors and/or associated weights. For example, account owners who have transactions with a HARLEY-DAVIDSON store might be identified as being highly likely to drive a motorcycle.

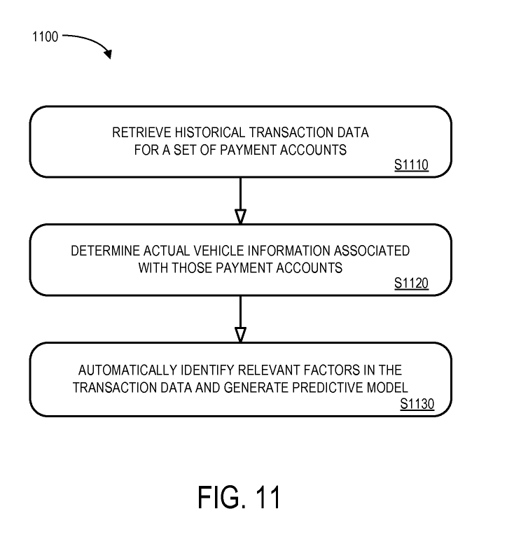

FIG. 11 is a flow chart illustrating how a predictive model might be generated according to some embodiments. At S1110, historical transaction data is retrieved from a set of payment accounts. Actual vehicle information associated with those payment accounts is determined at S1120. The relevant factors in the historical transaction data may be automatically identified at S1130 and a predictive model may be automatically generated.

Thus, according to some embodiments, vehicle information may be based at least in part on rules created by a predictive model trained with historical transaction information. According to some embodiments, a predictive model utilizes different groupings associated with different sets and/or weights of relevant factors. For example, depending on high level grouping, different variables may be significant and/or relevant and the weightings of common variables may be different.

In general, and for the purposes of introducing concepts of embodiments of the present invention, a computer system may incorporate a “predictive model.” As used herein, the phrase “predictive model” might refer to, for example, any of a class of algorithms that are used to understand relative factors contributing to an outcome, estimate unknown outcomes, discover trends, and/or make other estimations based on a data set of factors collected across prior trials. Note that a predictive model might refer to, but is not limited to, methods such as ordinary least squares regression, logistic regression, decision trees, neural networks, generalized linear models, and/or Bayesian models. The predictive model is trained with historical transaction information, and may be applied to current or test transactions to determine vehicle information.

The predictive model generator 1050 may operate generally in accordance with conventional principles for predictive models, except, as noted herein, for at least some of the types of data to which the predictive model component is applied. Those who are skilled in the art are generally familiar with programming of predictive models. It is within the abilities of those who are skilled in the art, if guided by the teachings of this disclosure, to program a predictive model to operate as described herein. The predictive model generator 1050, in various implementation, may include one or more of neural networks, Bayesian networks (such as Hidden Markov models), expert systems, decision trees, collections of decision trees, support vector machines, or other systems known in the art for addressing problems with large numbers of variables. According to some embodiments, the predictive model(s) are trained on prior data and vehicle types known to the credit card company. The specific data and outcomes analyzed may vary depending on the desired functionality of the particular predictive model. The particular data parameters selected for analysis in the training process may be determined by using regression analysis and/or other statistical techniques known in the art for identifying relevant variables in multivariable systems.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method, comprising:
retrieving, from a transaction database, transaction information associated with payments made via a payment account associated with an account owner;
analyzing, by a computer processor, the retrieved transaction information to automatically determine vehicle information associated with the account owner; and
outputting the automatically determined vehicle information.

2. The method of claim 1, wherein the vehicle information is associated with at least one of: (i) an automobile, (ii) a truck, (iii) a construction vehicle, (iv) a motorcycle (v) a boat, (vi) a snowmobile, and (vii) an airplane.

3. The method of claim 1, wherein the payment account is associated with at least one of: (i) a credit card account, (ii) a debit card account, (iii) a bank account, and (iv) a pre-paid card account.

4. The method of claim 1, wherein the transaction information comprises at least one of: (i) an account identifier, (ii) a merchant identifier, (iii) a date, (iv) a time of day, (v) a payment amount, and (vi) a payment description.

5. The method of claim 1, wherein the vehicle information comprises estimated driving information.

6. The method of claim 5, wherein the estimated driving information is associated with at least one of: (i) an estimated amount of miles driven by the account owner, (ii) an estimated amount of miles driven by the account owner's household, and (iii) an estimated amount of miles driven by the account owner's business.

7. The method of claim 5, wherein the analyzing is associated with at least one of: (i) a type of fuel purchased, (ii) an amount of fuel purchased, (iii) a fuel purchase frequency, (iv) an average price of fuel, (v) an average miles-per-gallon vehicle rating, (vi) a city or highway average miles-per-gallon vehicle rating, (vii) merchant information, (viii) location information, (ix) service station purchases, (x) demographic information, and (xi) predicted vehicle ownership information.

8. The method of claim 1, wherein the vehicle information comprises predicted vehicle ownership information.

9. The method of claim 8, wherein the predicted vehicle ownership information is associated with at least one of: (i) a predicted vehicle type, (ii) a predicted vehicle manufacturer, (iii) a predicted vehicle model, and (iv) a plurality of vehicles.

10. The method of claim 8, wherein the predicted vehicle ownership information is associated with at least one of: (i) predicted vehicle ownership information for the account owner, (ii) predicted vehicle ownership information for the account owner's household, and (iii) predicted vehicle ownership information for the account owner's business.

11. The method of claim 8, wherein the analyzing is associated with at least one of: (i) a type of fuel purchased, (ii) an amount of fuel purchased, (iii) a fuel purchase frequency, (iv) an average price of fuel, (v) an average miles-per-gallon vehicle rating, (vi) a city or highway average miles-per-gallon vehicle rating, (vii) merchant information, (viii) location information, (ix) service station purchases, (x) demographic information, (xi) a vehicle replacement part purchase, and (xii) estimated driving information.

12. The method of claim 1, further comprising:
automatically identifying relevant factors in the transaction database.

13. The method of claim 1, further comprising:
generating a confidence level associated with the vehicle information.

14. A non-transitory, computer-readable medium having stored therein instructions that, upon execution, cause a computer processor to perform a method, the method comprising:
retrieving, from a transaction database, transaction information associated with payments made via a payment account associated with an account owner;
analyzing, by a computer processor, the retrieved transaction information to automatically determine vehicle information associated with the account owner; and
outputting the automatically determined vehicle information.

15. The medium of claim 14, wherein the vehicle information comprises at least one of: (i) estimated driving information, and (ii) predicted vehicle ownership information.

16. The medium of claim 15, wherein the vehicle information is associated with at least one of: (i) the account owner, (ii) the account owner's household, and (iii) the account owner's business.

17. The medium of claim 16, wherein the analyzing is associated with at least one of: (i) a type of fuel purchased, (ii) an amount of fuel purchased, (iii) a fuel purchase frequency, (iv) an average price of fuel, (v) an average miles-per-gallon vehicle rating, (vi) a city or highway average miles-per-gallon vehicle rating, (vii) merchant information, (viii) location information, (ix) service station purchases, (x) demographic information, and (xi) a vehicle replacement part purchase.

18. An apparatus, comprising:
a transaction database storing transaction information associated with payments made via a payment account associated with an account owner; and
an analyzing platform to: (i) retrieve transaction information from the transaction database, (ii) analyze the retrieved transaction information to determine vehicle information associated with the account owner, and (iii) output the automatically determined vehicle information.

19. The apparatus of claim 18, wherein the vehicle information comprises at least one of: (i) estimated driving information, and (ii) predicted vehicle ownership information.

20. The apparatus of claim 19, wherein the vehicle information is associated with at least one of: (i) the account owner, (ii) the account owner's household, and (iii) the account owner's business.

21. The apparatus of claim 20, wherein the analyzing is associated with at least one of: (i) a type of fuel purchased, (ii) an amount of fuel purchased, (iii) a fuel purchase frequency, (iv) an average price of fuel, (v) an average miles-per-gallon vehicle rating, (vi) a city or highway average miles-per-gallon vehicle rating, (vii) merchant information, (viii) location information, (ix) service station purchases, (x) demographic information, and (xi) a vehicle replacement part purchase.
